(19) United States
(12) Patent Application Publication
(10) Pub. No.: US 2009/0255486 A1
(43) Pub. Date: Oct. 15, 2009

(54) COMBINATION PET COLLAR AND LEASH

(76) Inventors: PAUL V. THOMPSON, Marshall, MO (US); Kimberly A. Thompson, Marshall, MO (US); Francis D. Thompson, Marshall, MO (US); Rita A. Thompson, Marshall, MO (US)

Correspondence Address: INTELLECTUAL PROPERTY CENTER, LLC, 9233 WARD PARKWAY, SUITE 100, KANSAS CITY, MO, 64114, US

(21) Appl. No.: 12/421,015

(22) Filed: Apr. 9, 2009

Related U.S. Application Data
(60) Provisional application No. 61/123,540, filed on Apr. 9, 2008.

(51) Int. Cl. A01K 27/00; B65H 75/34

(52) U.S. Cl. 119/794

(57) ABSTRACT

The present invention provides a combination pet collar and leash adapted for operation between a retracted position and an extended position, the combination including a pet collar adapted for wear by a pet and including collar assembly in communication with a leash assembly associated with a handle, the collar assembly including a housing having a circular structure in communication with a segmented region by a passageway, the housing adapted for receiving a retraction mechanism for rotateable receipt of the leash where the retraction mechanism includes a resilient member adapted for biasing a spool adapted for rotatably receiving the leash. A pair of complementary fasteners is positioned along the collar and the handle for securing the handle along the collar with the leash assembly overlying the collar assembly in the retracted position. The leash rotatably extends from the collar assembly towards the leash assembly where the handle is spaced a distance from the collar in the extended position and the handle and the collar present common visual elements.

### CROSS-REFERENCE TO RELATED APPLICATION

This application claims the benefit of the prior filed U.S. provisional application No. 61/123,540 filed Apr. 9, 2008 which is incorporated herein by reference.

### FIELD OF THE INVENTION

This invention relates generally to a pet collar and more specifically to a collar for a pet with a retractable leash extending from the collar to a flexible handle.

### BACKGROUND OF THE INVENTION

Several attempts have previously been made regarding a retractable leash for a pet. However, these attempts have limitations which are addressed by the current invention. For example some attempts to provide a retractable leash include bulky coiling mechanisms which may catch on surrounding objects and cause the pet to choke or die. Other attempts include unnecessarily weighted mechanisms which cause undue strain around the necks of small pets. Some other attempts provide a leash which is wrapped around the pets neck, again providing for unsafe conditions for the pet. There therefore exists a need for a streamlined pet collar which takes into account many of these health concerns by providing an integrated collar and leash device which is suitable for small pets and large pets while providing a simple and easy to use retractable leash.

### SUMMARY OF THE INVENTION

The present invention provides a combination pet collar and leash adapted for operation between a retracted position and an extended position, the combination including a pet collar adapted for wear by a pet and including a collar assembly in communication with a leash assembly associated with a handle, said collar assembly including a housing having a circular structure in communication with a segmented region at a passageway, said housing adapted for receiving a retraction mechanism for rotateable receipt of said leash where said retraction mechanism includes a resilient member biasing said spool for rotatably receiving said leash. A pair of complementary fasteners is positioned along said collar and said handle for securing said handle along said collar with said leash assembly overlying said collar assembly in said retracted position. In the extended position, said leash extends from said collar assembly towards said leash assembly wherein said handle is separated from said collar, said handle and said collar present common visual elements.

### BRIEF DESCRIPTION OF THE DRAWINGS

FIG. 1 illustrates a perspective view of the combination pet collar and retractable leash in accordance with one embodiment of the present invention.

FIG. 2 rear perspective view of the combination pet collar and retractable leash illustrated in FIG. 1.

FIG. 3 is a partial rear elevation of the combination pet collar and retractable leash illustrated in FIG. 3.

FIG. 4 is a semi-exploded perspective view of a collar assembly operably connected to a leash assembly.

FIG. 5 is a top perspective view of a collar assembly.

FIG. 6 is a cross-sectional view of the collar assembly taken along line 6 in FIG. 5.

FIG. 7 is side elevation of an alternative embodiment of the present invention.

FIG. 8 is a semi-exploded perspective view of the alternative embodiment of FIG. 7.

### DETAILED DESCRIPTION OF THE INVENTION

### I. Introduction

As required, detailed embodiments of the present invention are disclosed herein: however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

### II. Combination Pet Collar and Leash

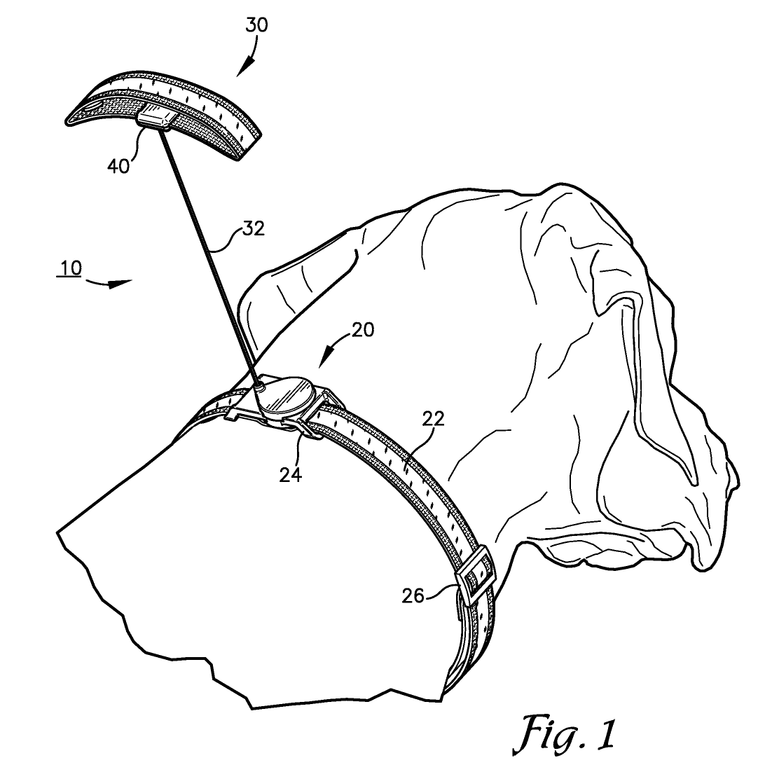

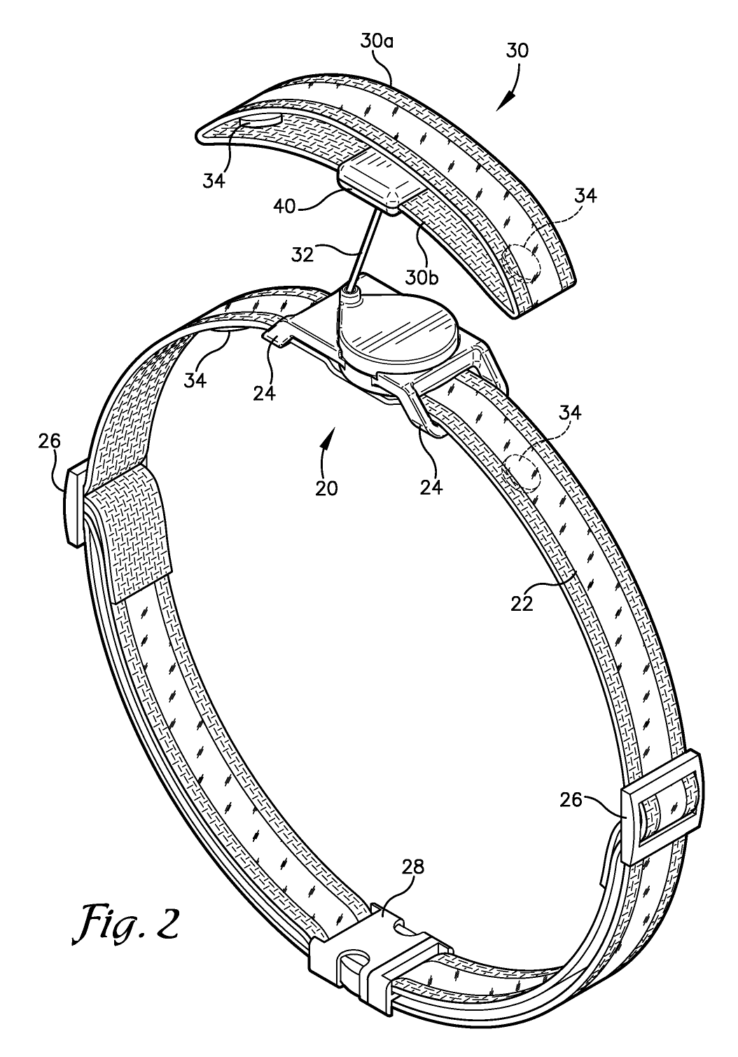

With reference to the drawings, the combination collar and retractable handle are generally referred to by numeral 10. FIG. 1 illustrates a handle 30 being separated from a collar 22 by a leash 32, the combination being generally in an extended position. The collar 22 is generally adapted for wear around a pet's neck with a pair of adjusters 26 being operationally spaced apart for centrally aligning a collar assembly 20 on the pet. A releasable clip 28 is illustrated in FIG. 2 opposite the collar assembly 20, the clip 28 being adapted for removal of the combination collar and retractable handle 10.

Generally, the collar 22 may be constructed using many different materials including those with a visual surface adapted with a visual element extending circumferentially along the collar 22. Similarly, the leash 32 may be constructed from a variety of known materials, but is preferably fabricated from a resilient, light-weight material which may be adapted for repetitive rotation.

The collar assembly 20 is further illustrated in FIG. 2 with the handle 30 in the extended position and including an upper layer 30a and a lower layer 30b with a pair of fasteners positioned therebetween. In the extended position the leash 32 is passed from the collar assembly 20 to a leash assembly 40. A variety of fasteners 34 may be utilized for fastening the handle 30 to the collar 22, but preferably, non-mechanical, magnetic fasteners 34 which may be covered by material for placement along the surfaces to be secured.

Magnet fasteners in association with the present invention provides several advantages over traditional fasteners in that they limit outward obstructions associated with the handle 30 thereby reducing the likelihood of the handle 30 becoming entangled with surrounding objects and potentially causing safety concerns for the pet. In addition the interiorly positioned fastener 26 facilitates a complementary visual element associated with the handle 30 upper layer 30a and the collar 22, providing an aesthetically pleasing seamless appearance to the combination collar and retractable handle 10 when the handle 30 is retracted to the retracted position. The fasteners 34 may be circular and may be positioned symmetrically in relation to the leash assembly 40 or the fasteners 34 may extend throughout the handle 30 for securing the handle 30 to the collar 22 in the retracted position. Because the fasteners 34 allow joined surfaces to be joined without the need for outwardly extending obstructions, unnecessary entanglement is promoted. As a point of reference, the outer area along the surfaces to be joined associated with the interiorly positioned fastener 34 is generally referred to herein as a region of connectivity, and the surfaces to be joined are in contact at these areas of connectivity.

The pair of adjusters 26 are illustrated as being symmetrically positioned along the collar 22, aligning the collar assembly 20 midway therebetween. The collar assembly 20 includes a generally rectangular housing 36 with a generally planar rear surface 36a and a pair of guides 46′, 46″, each including a pair of downwardly depending arms 46a with a retainer 46b traversing the arms 46a. The pair of guides 46′, 46″ generally present a channel for receiving the collar 22 longitudinally along the rear surface 36a. The housing 36 and guides 46′, 46″ may be fabricated from a number of known materials including plastic using a number of known fabrication processes used to produce a durable, weather resistant product which is lightweight. Two fasteners 34 are also illustrated on the underside of the collar 22, the fasteners 34 being adapted for securing the overlying handle 30 along the outer surface of the collar 22 while limiting engagement with any surrounding objects, thereby reducing the risk caused by catching the collar 22 on surrounding objects.

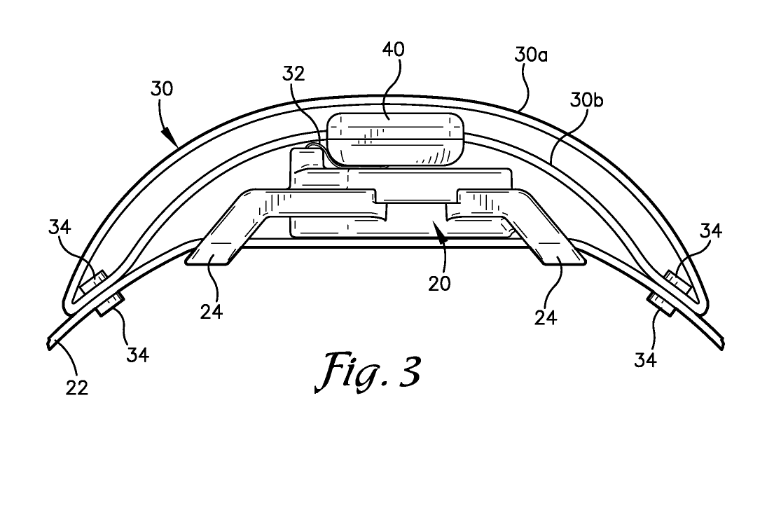

FIG. 3 illustrates the handle in the retracted position with the collar assembly 20 near said leash assembly 40 and the handle 30 being generally secured to the collar 22 in an overlying orientation at the region of connectivity. The collar 22 is illustrated extending longitudinally along the generally planar rear surface 36a of the housing 36. The collar assembly 20 is illustrated with the generally rectangular housing 36 extending between the depending arms 46a with an internally configured circular structure 50 and a cover 58 securely positioned thereon. A cylindrical guide 64 extends outwardly from the cover 58 and is adapted for reciprocal receipt of the leash 32 as the handle 30 travels between the extended and retracted positions. Generally, the cylindrical guide 64 is parallel to and offset from an axis of rotation associated with a spool 54 housed beneath the cover 58 within the circular structure 50.

The collar assembly 20 is exemplarily associated with the lower layer 30b of the handle 30 and is adapted for securing the leash 32 to the handle 30. In the retracted position, the regions of connectivity associated with the handle 30 are secured to the regions of connectivity associated with the collar 22. The regions of connectivity associated with the handle 30 are generally opposite and separated from fasteners 34 by the lower layer 30b and the regions of connectivity associated with the collar 22 are generally opposite and separated from the fasteners 34 by the collar 22.

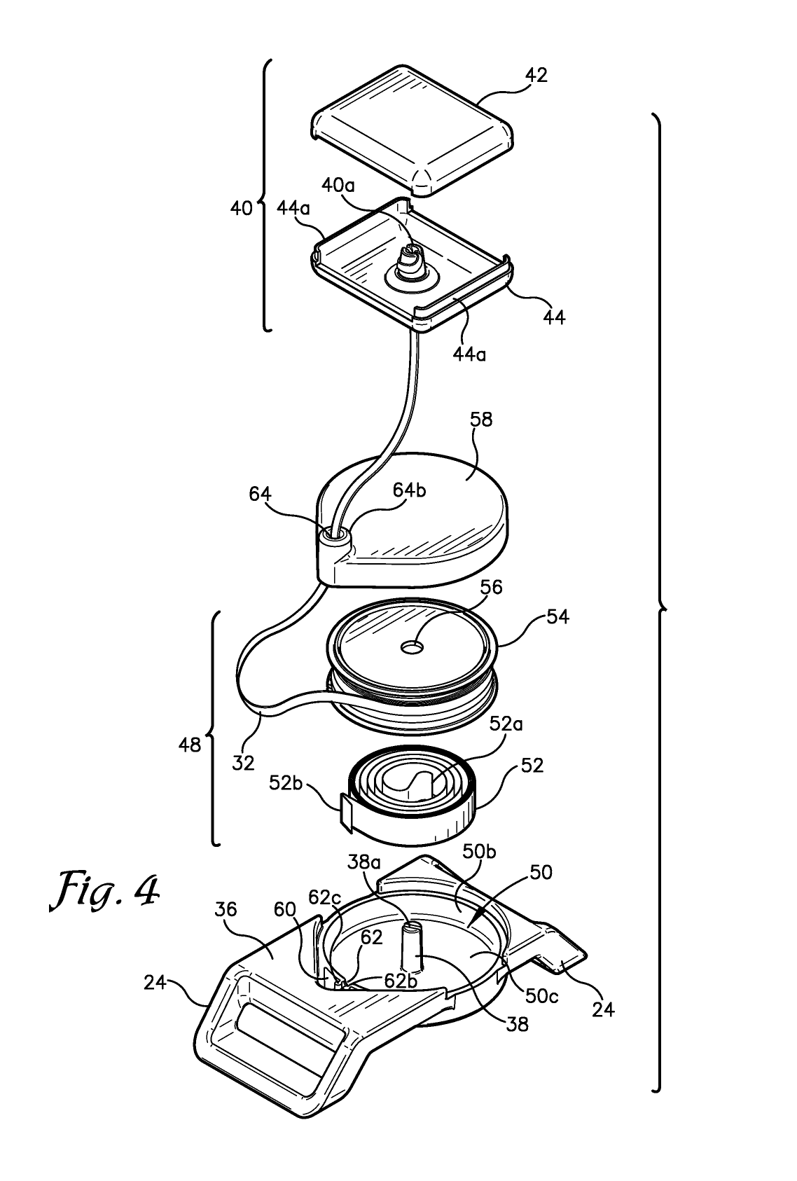

FIG. 4 illustrates the collar assembly 20 in communication with the leash assembly 40 along the leash 32. The generally rectangular housing 36 associated with the collar assembly 20 also includes a cylinder structure 50 with sidewalls 50b circumnavigating along a generally planar support surface 50c and adapted for supporting the spool 54. The circular structure 50 terminates at the planar support surface 50c which is spaced from the surface of the rectangular housing 36. Centrally positioned within the circular structure 50, extending upwardly from the support surface 50c is an axle 38 adapted for receiving the spool 54 at a central aperture 56 associated with the spool 54. The spool 54 is generally disposed within the circular structure 50 and is adapted for rotatably receiving the leash 32. The spool 54 and other portions of the collar assembly 20 may be made of metal, or any light weight plastic material. The spool 54 has an outer cylindrical surface (not shown) upon which the leash 32 may be wound. A resilient member 52 such as a spring or coil is positioned within the circular structure 50 with one end 52a being fixed upon or within the axle 38 and the other end 52, presenting a recurved segment, affixed to the inner cylindrical surface (not shown) of the spool 54. As illustrated the axle 38 may have a slot 38a therein for receiving one end of the coil 52a. The cover 58 is secured to the circular structure 50 and is adapted for securely retaining the spool 54 during rotation.

Generally, the invention is in the retracted position, the extended position or is traveling therebetween. During travel of the handle 30 from the retracted position to the extended position, the spool 54 rotates about the axle 38 releasing the wound leash 32 and allowing the handle 30, in communication with the collar 22, to extend. Generally, the leash 32 is rotated about the spool 54, with one end being fixed upon the spool 54 by means of a knot for example, the other end being fixed to the leash assembly 40. As the spool 54 rotates about the axle 38 in one direction, it causes the coil 52 to impart a torque to the spool 54. Upon reaching the extended position, the coil 52, operably connected to the spool 54, is biased towards the retracted position. Upon engagement from the extended position towards the retracted position, the handle 30 travels towards the collar 22 as the coil 52 rotates the spool 54 about the axle 38 in the opposite direction, winding the leash 32 upon the spool 54.

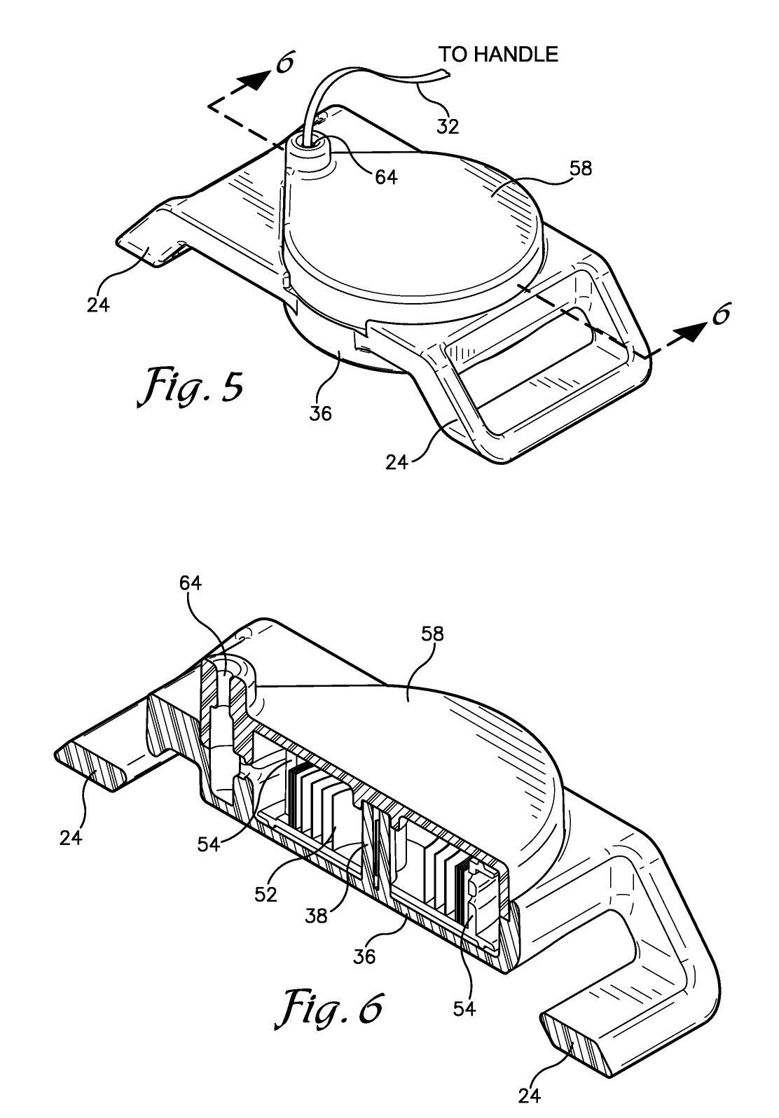

As illustrated in FIGS. 4-6, a segmented region 60 is located adjacent to and separated from the circular structure 50 by a passageway 62. The segmented region 60 is aligned with a cylindrical guide 64 associated with the cover 58 and is adapted for threading the leash 32 upon the spool 54 during retraction inwardly and for frictionally controlling the leash 32 as it extends outwardly from the spool 54. The passageway 62 generally has a pair of finger-like projections 62b which extend from the circular structure 50 towards the segmented region 60 and are adapted to frictionally engage the leash 40 during travel across the projections 62b through the passageway 62 to the cylindrical guide 64. On the end of each finger-like projection 62b is a boss segment 62c adapted to facilitate controlled movement of the leash 32 and may be alternatively configured depending on the leash properties and the degree of control desired. The cylindrical guide 64 also includes a radiused edge 64b to limit wear on the traveling leash 32. In addition, the segmented region 60 in association with the cylindrical guide 64 which is positioned radially outwardly from the axle 38 and perpendicular to the rotating leash 32 provides additional unexpected benefits including improved control for the traveling leash.

The collar assembly 20 as illustrated in FIG. 4 includes a generally rectangular upper assembly 42 and a complementary lower assembly 44 with a slotted hub 40a extending upwardly therefrom. The collar assembly 20 is generally adapted for securing the leash 32 to the handle 30. As such, the upper and lower assembly 42, 44 may include a variety of alternative configuration and is not limited to the specific rectangular configuration illustrated. The illustrated lower assembly 44 also includes a plurality of tabs 44a adapted to facilitate a secure connection between the lower and upper assemblies 44, 42. As illustrated the slotted hub 40a is secured to the lower assembly 44 and is adapted for connection to the second end of the leash 32, for example by a knot. The collar assembly 20 may be made from a variety of known materials including, but not limited to plastic. In addition, a number of known fastening devices and techniques may be employed for alternatively securing the upper and lower assemblies 42, 44 and for securing the leash 32 to the leash assembly 40.

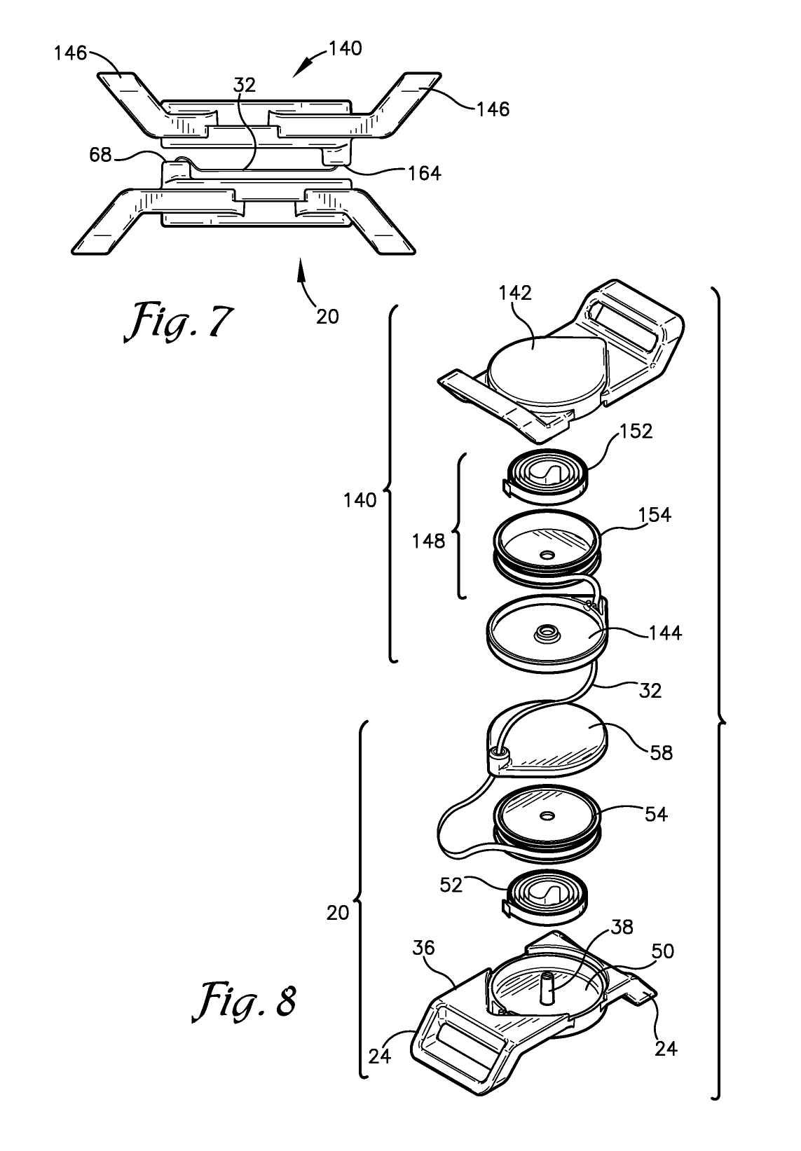

An alternative embodiment is illustrated in FIGS. 7 and 8 with both the collar assembly 20 and the alternative leash assembly 140 including a resilient member. The illustrated collar assembly 20 is consistent with the previous description, with the alternative leash assembly 140 also being similarly configured. In particular, the leash assembly 140 includes an upper leash structure 142 adapted for secure connection to the lower leash structure 144 with a leash spool 154 engaged by a leash coil 152 for biased rotation of the leash spool 154. The collar assembly 20 is in communication with the leash assembly 140 via leash 32. In the retracted position, illustrated in FIG. 7, the alternative leash assembly 140 overlies the collar assembly 20 with the cylindrical guide 68 offset from a cylindrical leash guide 164 extending downwardly from a lower leash structure 144. In addition, a pair of upwardly extending leash guides 146 extend from the upper leash structure 142 and are adapted for receiving the handle 30 extending longitudinally therealong.

While the invention has been described with respect to specific examples including presently) preferred modes of carrying out the invention, those skilled in the art will appreciate that there are numerous variations and permutations of the above described systems and techniques that fall within the spirit and scope of the invention as set forth in the appended claims.

Having thus described the invention what is claimed as new and desired to be secured by Letters Patent is:

1. A combination pet collar and leash adapted for operation between a retracted position and an extended position, said combination comprising:
a pet collar adapted for wear by a pet and including a collar assembly in communication with a leash assembly associated with a handle,
said collar assembly including a housing having a circular structure in communication with a segmented region by a passageway, said housing adapted for receiving a retraction mechanism for rotateable receipt of said leash.
said retraction mechanism including a resilient member rotatably biasing a spool to receive said leash,
a pair of complementary fasteners positioned along said collar and said handle for securing said handle along said collar with said leash assembly overlying said collar assembly in the retracted position,
said leash extending from said collar assembly toward said leash assembly wherein said handle is spaced a distance from said collar in said extended position, and
said handle and said collar presenting a common visual element.

2. The combination of claim 1 wherein said handle further comprises:
an upper layer and a lower layer associated with said fasteners spaced along said handle, and
said handle being secured to said collar at a region of connectivity by said fasteners positioned above said lower layer and below said collar.

3. The combination of claim 1 wherein said collar assembly further includes a pair of downwardly depending guides presenting a channel for receiving said collar extending therethrough providing frictional engagement between said collar and said collar assembly.

4. The combination of claim 1 wherein said circular structure further includes a sidewall circumnavigating along a planar support surface with an axle centrally disposed therein extending upwardly therefrom, said axle adapted for receiving said spool.

5. The combination of claim 1 wherein said circular structure is adapted for housing said spool beneath a cover with a cylindrical guide extending upwardly therefrom.

6. The combination of claim 5 wherein said cylindrical guide is offset from an axis of rotation associated with said spool, said cylindrical guide adapted for receipt of said leash in said retracted orientation.

7. The combination of claim 1 wherein said leash assembly further includes an upper structure connectably secured to a lower structure.

8. The combination of claim 7 wherein said leash assembly further includes a resilient member for biased rotation of a leash spool with the leash passing through a cylindrical leash guide associated with said lower structure.

9. A combination pet collar and leash adapted for operation between a retracted position and an extended position, said combination comprising:
a pet collar adapted for wear by a pet and including a centrally positioned collar assembly,
a handle including a leash assembly overlying said collar assembly, said handle including an upper layer and a lower layer encircling said fasteners associated with said handle, said handle being secured to said collar in said retracted position,
a pair of complementary non-mechanical fasteners positioned along said collar and said handle for securing said handle along said collar in the retracted position
a leash extending from said collar assembly to said leash assembly, said leash connectable secured to said handle and said collar in said extended position,
said collar assembly including a housing extending upwardly from a pair of downwardly depending arms associated with a pair of guides,
a cover with a cylindrical guide offset from a rotation axis associated with a rotatable spool housed within a circular structure associated with a housing,
said cylindrical guide adapted for passage of said leash between said extended position and said retracted position, and
said handle and said collar presenting a common visual element.

10. A combination pet collar and leash adapted for operation between a retracted position and an extended position, said combination comprising:
a pet collar adapted for wear by a pet and including a collar assembly and plural fasteners,
a leash including a handle with a leash assembly connecting said handle to one end of said leash, the other end of said leash connectably secured to said collar assembly
said leash assembly overlying said collar assembly and further including a lower leash structure separated from an upper leash structure by a leash retraction mechanism,
said handle being secured to said collar at plural regions of connectivity,
said leash extending a distance from said collar to said handle in said extended position.
said leash assembly in communication with said collar assembly and including a lower leash structure separated from said upper leash structure by said retraction mechanism with a cylindrical leash guide extending downwardly therefrom, said cylindrical leash guide being adapted for passage of said leash from said collar assembly to said leash assembly, and
said handle and said collar presenting a common visual element.
